(19) United States
(12) Patent Application Publication
(10) Pub. No.: US 2013/0331060 A1
(43) Pub. Date: Dec. 12, 2013

(54) MOBILE PHONE APPLICATION, SYSTEM, AND METHOD FOR SENDING POSTCARDS AND OBTAINING MAILING ADDRESSES

(71) Applicant: Postcard on the Run, Los Angeles, CA (US)

(72) Inventor: Joshua M. Brooks, Los Angeles, CA (US)

(73) Assignee: Postcard on the Run, Los Angeles, CA (US)

(21) Appl. No.: 13/967,232

(22) Filed: Aug. 14, 2013

Related U.S. Application Data
(63) Continuation of application No. PCT/US2012/025641, filed on Feb. 17, 2012.
(60) Provisional application No. 61/443,874, filed on Feb. 17, 2011.
(60) Provisional application No. 61/482,452, filed on May 4, 2011.

(51) Int. Cl. H04W 4/12

(52) U.S. Cl. CPC H04W 4/12
USPC 455/407; 455/406

(57) ABSTRACT

Systems for sending postcards and other mail items from a mobile device such as a mobile phone, software applications for preparing and sending such items, and methods, for example, computer and network implemented methods of simplifying the sending of postcards. Using an application running on a mobile device or mobile phone, a user can prepare and send postcards or send other mail items through the mail to selected recipients. Mailing addresses are automatically obtained from an address book, for example, on the mobile device, and if a recipient's address is missing, an electronic message such as an e-mail or a text message can automatically be sent to the recipient requesting the mailing address. Once the address is received, the postcard is printed and mailed. Postcards can include an image or picture selected or taken by the user and a personal message from the user to the recipient. The user can be charged a reasonable fee per postcard sent and the mailing address can automatically be stored in the address book for later use.

### RELATED PATENT APPLICATIONS

This patent application is a continuation of PCT/US2012/025641 filed on Feb. 17, 2012, which claims priority to and the benefit of U.S. Provisional Patent Application No. 61/443,874, filed Feb. 17, 2011, and U.S. Provisional Patent Application No. 61/482,452, filed May 4, 2011, the contents of all of which are incorporated herein by reference.

### FIELD OF THE INVENTION

This invention relates to computers, software, digital mobile electronic devices, mobile telephony, and systems and methods for sending postcards and other mail items and updating contact information.

### BACKGROUND OF THE INVENTION

Since long before electronic forms of communication were invented, people have communicated over long distances through mail physically delivered from one place to another. Postcards have long been sent with a picture or illustration on one side and address information, a stamp, and a short message on the other side. People have communicated with family, friends, and contacts by sending postcards when they have been traveling, for example. Postcards have often been sent with pictures of the places the travelers have been to. Postcards are still used for this purpose today, but significant time is required to purchase, fill out, and send postcards to many recipients and time is often limited when traveling. In addition, planning is required to have the necessary mailing addresses to mail postcards to various recipients. In today's digital age, many people do not maintain complete contact information of all of the people that they may wish to send a postcard to. Furthermore, postcards purchased in stores lack the flexibility and personal touch of being able to send postcards with unique pictures or with pictures of the person sending the postcard.

In addition, mobile phones have been used for some time that allow users to take pictures and to send the pictures to others by e-mail, by text message, or by posting on a website or a web-based social network, as examples. Such electronic communications, however, have become common in this day, and physical postcards received through the mail offer a personal touch not provided by electronic communications. In addition, many people still exist in society who do not use computers or smart phones and do not have access to e-mail, text messages, websites, or web-based social networks. Many such people, however, have access to receive mail through the Post Office or other common carriers. As a result, needs or potential for benefit exist for equipment, apparatuses, software, and methods that allow people to send postcards more easily, to manage contact information including mailing addresses more efficiently, and to send postcards with pictures that are more personal or that contain images that are more specifically meaningful to the sender and recipient of the postcard. Other needs or potential for benefit or improvement may also be described herein or known in the mobile phone, computer, software, or mail industries. Room for improvement exists over the prior art in these and other areas that may be apparent to a person of ordinary skill in the art having studied this document.

### SUMMARY OF PARTICULAR EMBODIMENTS OF THE INVENTION

This invention provides, among other things, various systems for sending postcards from a mobile device such as a mobile phone, certain software applications, for example, for a mobile device, for sending mail items, and certain methods, for example, of simplifying the sending of postcards.

Various embodiments provide, for example, as an object or benefit, that they partially or fully address or satisfy one or more needs, potential areas for benefit, or opportunities for improvement described herein, or known in the art, as examples. Certain embodiments provide, for example, equipment, apparatuses, software, and methods that allow people to send postcards more easily, to manage contact information including mailing addresses more efficiently, to send postcards with pictures that are more personal or that contain images that are more specifically meaningful to the sender and recipient of the postcard, or a combination thereof.

Specific embodiments of the invention include various systems for sending mail items or postcards from mobile phones. Such systems may include, for example, a software application running on multiple mobile devices, such as mobile phones, at least one printing and mailing facility, and at least one billing module. In a number of embodiments, the mobile devices, the printing and mailing facility, and the billing module are in communication through at least one network, for example. Further embodiments include various software applications for a mobile device for sending a mail item or for preparing and sending a postcard. Various of these different embodiments include a user interface component that provides for selection by the user to send the mail item or prepare and send the postcard, an image selection component (e.g., for postcard embodiments) that provides for user selection of a picture for the postcard, and a message input component that provides for the user to enter a personal message for the mail item or postcard, as examples. Moreover a number of embodiments include a recipient selection component that provides for the user to select a recipient for the mail item or postcard from an address book database, a mailing address retrieval component that obtains an address for the recipient from the address book database for the mail item or postcard, and a mailing address obtaining component that contacts the recipient of the mail item or postcard for the mailing address of the recipient if the address book database does not contain the mailing address of the recipient. For example, in many embodiments, the mailing address obtaining component automatically sends an electronic message to the recipient requesting the mailing address. Further, various embodiments include a payment component that obtains authorization from the user for payment for sending the mail item or postcard, and a communication component that automatically sends the picture (e.g., for postcard embodiments), the personal message, and the mailing address to the at least one printing and mailing facility via the at least one network, for instance, for printing the postcard and mailing to the recipient.

Moreover, some embodiments further include a holding component that stores the picture (e.g., in postcard embodiments), the personal message, and identification of the recipient. In certain embodiments, the holding component automatically instructs the communication component to send the picture, the personal message, and the mailing address to the at least one printing and mailing facility for printing and mailing to the recipient when the mailing address obtaining component obtains the mailing address from the recipient. Further, in some embodiments, the mailing address obtaining component automatically updates the address book for the recipient on the mobile device running the software application by adding the mailing address when the mailing address obtaining component obtains the mailing address from the recipient. Even further, in some embodiments, the image selection component provides for the user to select a picture taken by the mobile device running the software application, to select a picture from a picture gallery stored on the mobile device running the software application, or both. Further still, in some embodiments, the image selection component provides for the user to crop a picture, for example, for the postcard.

Other specific embodiments of the invention include various computer and network implemented methods, for instance, of simplifying the sending of postcards. Such methods may include, for example, at least certain acts. These acts may include, for example, acts of receiving, at a mobile device containing a digital processor, an instruction from a user to prepare a postcard, receiving, at the mobile device, a selection by the user of an image for the postcard, and receiving, at the mobile device (e.g., from the user) a personal message for printing on the postcard. Moreover, in a number of embodiments, such methods may include, for instance, acts of receiving (e.g., at the mobile device) a selection by the user of a recipient for the postcard, searching an address book for a mailing address for the recipient, and if the address book does not contain the mailing address for the recipient, automatically sending an electronic message to the recipient requesting the mailing address. Furthermore, in various embodiments, such methods may include, for example, acts of receiving (e.g., at the mobile device) authorization from the user for payment for sending the postcard, transmitting (e.g., over the network) from the mobile device to a printing and mailing facility, the image for the postcard, the personal message, and the mailing address, printing the postcard at the printing and mailing facility and mailing the postcard to the recipient. In a number of such embodiments, the image, the personal message, and the mailing address are all printed on the postcard.

In certain of these embodiments, if the address book does not contain the mailing address for the recipient, the method further includes (e.g., in the following order) after the act of sending the electronic message to the recipient requesting the mailing address, and before the act of printing the postcard at the printing and mailing facility, the acts of holding and storing the image, the personal message, and identification of the recipient prior to printing of the postcard, and receiving (e.g., from the recipient) the mailing address of the recipient. Further, some embodiments further include the acts of receiving (e.g., from the recipient) the mailing address of the recipient, and automatically updating the address book for the recipient by adding the mailing address.

Even further, in particular embodiments, the act of receiving (e.g., at the mobile device) a selection by the user of an image for the postcard, includes providing for the user to select a picture taken with the mobile device, prompting the user to select a picture from a picture gallery stored on the mobile device, prompting the user to select a picture from a picture gallery stored on a web-based social network site, prompting the user to crop the image for the postcard, or a combination thereof, as examples. Moreover, in some embodiments, the method includes an act of prompting the user to form a group of recipients for the postcard. In some embodiments, the user can select the group during the act of receiving (e.g., at the mobile device) the selection by the user of the recipient for the postcard. In a number of embodiments, when the user selects the group, copies of the postcard are sent to each recipient in the group.

In addition, various other embodiments of the invention are also described herein, and other benefits of certain embodiments may be apparent to a person of ordinary skill in the art.

### BRIEF DESCRIPTION OF THE DRAWINGS

FIG. 1 is a block diagram illustrating a system for sending mail items, including postcards, from mobile phones and a software application for a mobile device for preparing and sending a postcard; and

FIG. 2 is a flow chart illustrating a computer and network implemented method of simplifying the sending of postcards.

These drawings illustrate, among other things, examples of embodiments of the invention. Other embodiments, however, may differ.

### DETAILED DESCRIPTION OF EXAMPLES OF EMBODIMENTS

The subject matter described herein includes, as examples, various systems for sending mail item or postcards from a mobile device such as a mobile phone, certain software applications, for example, for a mobile device, for sending mail items or for preparing and sending postcards, and certain methods, for example, of simplifying the sending of mail item or postcards. As used herein, “postcards” includes holiday cards. In addition, many aspects described herein, may apply to other items sent by mail (i.e., other mail items) as well such as letters, invitations, packages, gifts, presents, candy, flowers, cookies, etc. Certain embodiments described herein are described for postcards specifically, but many aspects of these embodiments may apply to other mail items. Many other mail items, however, may not involve selection of an image or picture, or the printing thereof. Certain other mail items, however, in addition to postcards, such as T-shirts, calendars, and the like, may include pictures or other images that may be selected and printed, for instance, similarly to as described herein for postcards. Further, as used herein, “mail” includes deliveries via the postal service (e.g., the US Post Office) UPS, Federal Express, and other common carriers.

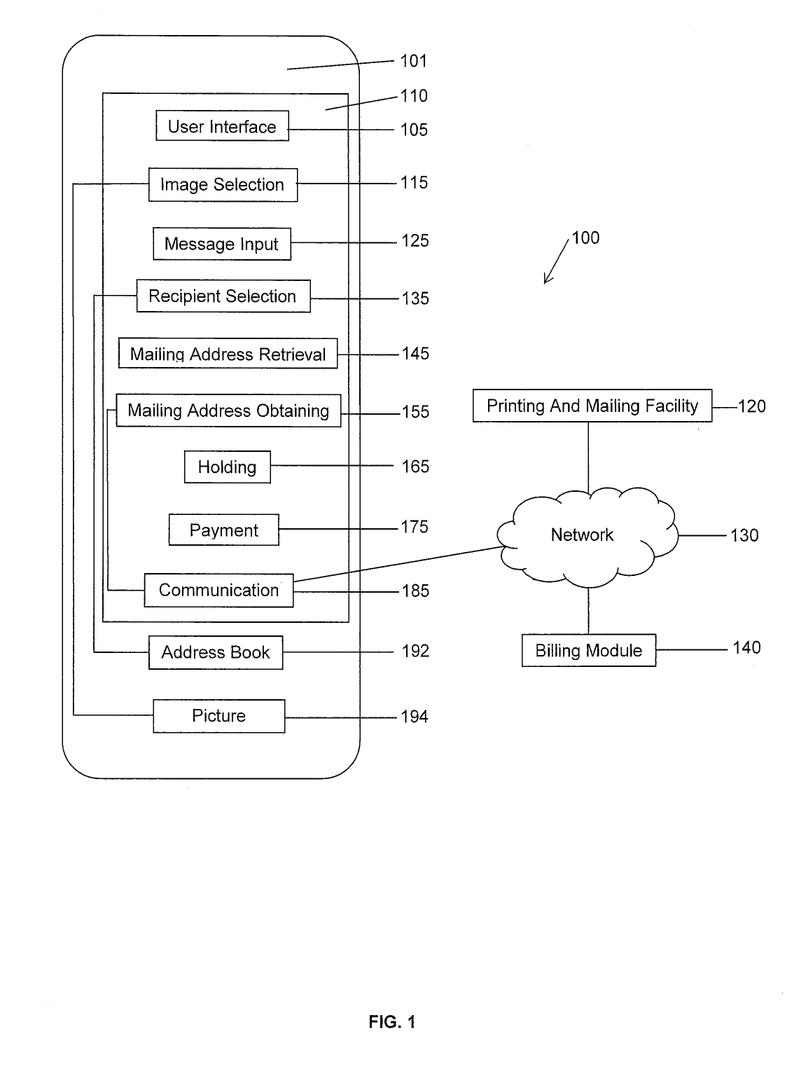

FIG. 1 illustrates an example of a system for sending mail items or postcards from mobile devices, such as mobile phones. In this particular embodiment, system 100 includes software application 110 running on mobile device 101. Application 110 is an example of a software application for a mobile device for preparing and sending a postcard or for sending a mail item, the software application in this example including the various components which are shown and described herein. Other embodiments may have just some of these components, additional components, or both, as further examples. Moreover, although one mobile device 101 is shown, in various embodiments, there may be multiple mobile devices, such as mobile phones, and different copies of application 110 may run on different mobile devices controlled by different users. In this embodiment, system 100 further includes printing and mailing facility 120 and billing module 140. In various embodiments, there may be one, at least one, or multiple printing and mailing facilities (e.g., 120), billing modules (e.g., 140), or both, as examples. In the embodiment illustrated, mobile phone 101, printing and mailing facility 120, and billing module 140 are in communication through network 130. In a number of embodiments, one, one or more, or multiple networks may be used (e.g., represented in FIG. 1 by network 130). For example, such networks may include a local area network, a wide area network, the Internet, a telephone network, a credit card network, a wireless network (e.g., WiFi), or a combination thereof, as examples.

In the embodiment shown, software application 110 includes various components, all loaded and operating, in this particular embodiment, on mobile device 101. In other embodiments, however, a number of these components may be loaded on or operating on a remote server or computer, as other examples, which may be part of the system for sending postcards. In such embodiments, the mobile device may communicate with such components via a network (e.g., such as described herein or known in the art).

In the embodiment illustrated, system 100 includes, on mobile device 101, user interface component 105 that provides for selection by the user, for instance, to prepare and send the postcard or mail item. A welcome screen may be provided, for instance, that may contain a logo or icon for sending a postcard or other mail item. For example, the user of a mobile phone may touch or click on an icon to launch application 110 to prepare and send a postcard. In this embodiment, system 100 and application 110 further includes image selection component 115 that provides for user selection of an image, such as a picture, for the postcard, for example. In certain embodiments, for example, the image selection component provides for the user to select a picture taken by the mobile phone (e.g., device 101) running the software application (e.g., 110). Further, in particular embodiments, the image selection component (e.g., 115) provides for the user to select a picture from a photo library or a picture gallery (e.g., 194) stored, for instance, on the mobile device or phone (e.g., 101) running the software application (e.g., 110). Even further, in a number of embodiments, the image selection component (e.g., 115) provides for the user to crop a picture for the postcard. In particular embodiments, the user may be able to edit the image or photograph in other ways, such as enhancing color, changing colors, changing to black and white, making a negative image, etc. Even further still, in certain embodiments, the image selection component (e.g., 115) provides for the user to add to the picture location or GPS coordinates where the picture was taken, the time, the date, a title, other text, a small globe or map showing where the picture was taken, or a combination thereof, as examples. Moreover, in certain embodiments, the user may be able to make or select an audio file that may be programmed into the postcard or other mail item, may be able to select a scratch and sniff feature, or both. In various embodiments, the user may be prompted to make such selections, perform such operations, or the like, as examples.

In this particular illustrated embodiment, system 100, mobile device 101, and application 110 further includes message input component 125 that provides for the user to enter a personal message, for example, for the postcard. Such a message may include text, for example, 200 or 250 characters. In some embodiments, a keyboard (e.g., soft keys) may be provided for the user to type in the message, for example. In particular embodiments, voice recognition software may be used, as another example. In a number of embodiments, the user may be able to sign the postcard, for example, with a finger. Moreover, in some embodiments, the user may be able to preview and approve the message, the picture, or both.

Further, the embodiment shown further includes recipient selection component 135 that provides for the user to select a recipient for the mail item or postcard, for example, from address book database 192. In some embodiments, the user may be prompted to select one or more recipients from the address book (e.g., 192). In the embodiment illustrated, address book 192 is shown on mobile device 101. In other embodiments, however, an address book may be stored remotely, for example, on a server or remote computer, and may be accessed, for instance, via a network (e.g., 130, for instance, via the Internet). In a number of embodiments, the user may touch or click on the name of the recipient to select the recipient to receive the postcard, for example.

The embodiment shown also includes mailing address retrieval component 145 that obtains a mailing address for the recipient from the address book database for the mail item or postcard. This may be performed automatically, for example. As used herein, “automatically” means that the function is performed without the user looking up the data (e.g., the mailing address). The user, however, may be prompted to confirm that the address is correct and the function may still be considered to be “automatic”. In the embodiment illustrated, system 100 and application 110 further includes mailing address obtaining component 155 that contacts the recipient of the may also mail item or postcard for the mailing address of the recipient if the address book database (e.g., 192) does not contain the mailing address of the recipient. In various embodiments, the mailing address obtaining component (e.g., 155) automatically sends an electronic message to the recipient requesting the mailing address, for example. Such an electronic message may be an e-mail, a text message, a message on a web-based social network, a social media alert, an in-app alert, a audio recording, an automated voice message, a video, or a combination thereof, as examples (e.g., via network 130). In some embodiments, the user may be prompted to authorize such an electronic message before it is sent. In a number of embodiments, the e-mail or message that is sent may be appealing, friendly, and simple, and may identify the user. In some embodiments, the message may include assurances that the recipient's address will be secure and kept confidential. Moreover, in certain embodiments, addresses, or other contact information, may be requested periodically or when prompted by the user, even when a postcard or other mail item is not being sent at that time. In some embodiments, for example, messages may be sent to all people in the user's address book where a mailing address or other piece of contact information is missing or incomplete. Moreover, in some embodiments, the user may be notified or reminders may be sent to the recipient if the recipient does not respond within a certain amount of time.

In the embodiment shown, system 100 further includes holding component 165 that stores the image or picture (e.g., selected via component 115, for instance, where the mail item is a postcard), the personal message (e.g., input via component 125), and identification of the recipient (e.g., selected via component 135). In some embodiments, mailing address obtaining component 155 automatically updates address book 192, for example, for the recipient by adding the recipient's mailing address to address book 192 when mailing address obtaining component 155 obtains the mailing address from the recipient. In this particular embodiment, address book 192 is located on mobile device 101 (e.g., phone) running software application 110. In other embodiments, the address book may be located remotely, as another example. In a number of embodiments, the mailing address obtaining component (e.g., 155) may obtain the address from the recipient, for example, with an API call. In various embodiments, the user may be notified when the address is received.

System 100 and application 110 further include, in the embodiment shown, payment component 175 that obtains authorization from the user for payment for sending the mail item or postcard. The user may be provided the cost of sending the mail item or postcard and may touch or click on an icon or soft button to authorize the payment, for example. In a number of embodiments, the user can pay with a credit card, debit card, prepaid card, or phone card, or may be able to have the cost added to the user's phone bill, or a combination thereof, as examples. In some embodiments, credit card information, for example, may be stored, for instance, on the mobile device, so the user does not have to enter the credit card number each time a mail item or postcard is sent. Moreover, in some embodiments, a user may be able to use a gift card, may be able to enter a coupon code, or both, as examples. Payment component 175 may contact billing module 140 (e.g., via network 130) to bill the user, for example. In certain embodiments, the holding component automatically instructs communication component 185 to send the picture, the personal message, and the mailing address to the (e.g., at least one) printing and mailing facility 120 for printing and mailing to the recipient when (i.e., after) mailing address obtaining component 155 obtains the mailing address from the recipient (e.g., provided payment has been authorized, for instance, via component 175).

Further, in the embodiment depicted, communication component 185 automatically sends the picture, the personal message, and the mailing address to the (e.g., at least one) printing and mailing facility (e.g., 120) via the (e.g., at least one) network (e.g., 130) for printing the postcard, for example, and mailing to the recipient. Printing and mailing facility 120 may include a printer (e.g., a color printer) that may print a high-quality image, for instance, of the picture or image on one side of the postcard. Another printer or the same printer may print the personal message and address on the other side of the postcard or on a card for other mail items. Then the postcard or other mail item may be mailed to the recipient via a mail delivery service or common carrier, for example. In some embodiments, the printing and mailing facility may include separate locations or buildings for printing and mailing. Further, in some embodiments, there may be multiple printing and mailing facilities at different locations (e.g., around the world). In particular such embodiments, the postcard, for example, may be printed and mailed from a facility that is relatively close to the recipient.

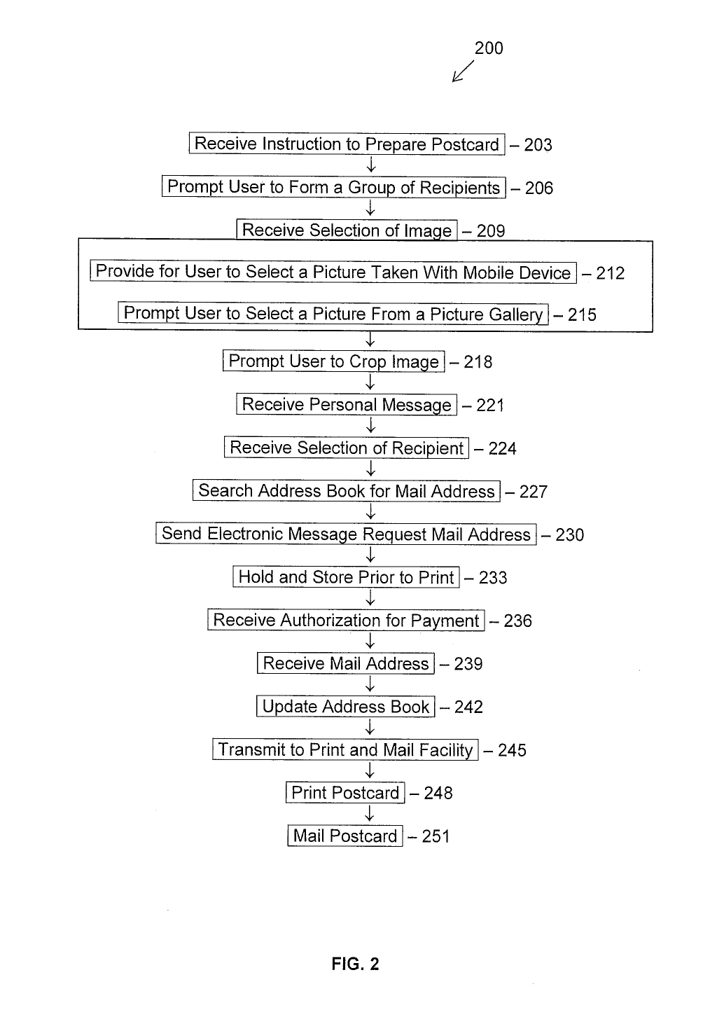

FIG. 2 illustrates an example of a method of simplifying the sending of postcards. Although FIG. 2 is described with respect to postcards, it may be used for other mail items as well, such as items described herein. In this particular embodiment, method 200 includes the acts illustrated. Other embodiments may have only some of the acts illustrated, may have additional acts, may have acts described above with reference to FIG. 1, or a combination thereof, as examples. Further, method 200 illustrates an example of an order in which various acts can be performed. Other embodiments, however, may be in a different order. In a number of embodiments, various methods, such as method 200 can be computer and network implemented, for example, via mobile devices, mobile phones, tablet computers, e-book readers, laptop computers, desktop computers, servers, the Internet, telephone networks, and the like.

In the embodiment illustrated, method 200 includes act 203 of receiving, at a mobile device (e.g., containing a digital processor, which may be running a software application, for instance, 110 described above) an instruction from a user to prepare a postcard. This instruction may be received, for example, by the user touching or clicking on a soft key, for instance. Method 200 also includes act 206 of receiving, at the mobile device, a selection by the user of an image for the postcard. In a number of embodiments, the user may be prompted to select from various alternatives for the image. For example, in the embodiment shown, act 209 of receiving, at the mobile device, a selection by the user of an image for the postcard includes act 212 of providing for the user to select a picture taken with the mobile device. In some embodiments, the user may be prompted to take a picture at this stage. Further, in certain embodiments, the user may be prompted to select a picture from a picture gallery (e.g., on the mobile device). In fact, method 200 further includes, within act 209 of receiving, at the mobile device, a selection by the user of an image for the postcard, further act 215 of prompting the user to select a picture from a picture gallery, for example, stored on the mobile device (e.g., 101 shown in FIG. 1) or, as another example, from a picture gallery stored on a web-based social network site. In the embodiment shown, method 200 further includes act 218 of prompting the user to crop the image for the postcard (e.g., to zoom in on more important subject matter within the image).

As shown, method 200 further includes act 221 of receiving, at the mobile device, from the user, a personal message for printing on the postcard, and act 224 of receiving, at the mobile device, a selection by the user of a recipient for the postcard. In this embodiment, method 200 also includes act 206 of prompting the user to form a group of recipients for the postcard. In certain embodiments, different groups may be formed, for instance, family, friends, colleagues, etc. In different embodiments, such an act may be performed at different times in the process. In various embodiments, the user may select groups before instructing to prepare the postcard (e.g., before act 203), after instructing to prepare the postcard (e.g., after act 203, as shown for act 206), or later in the process (e.g., in or after act 224). Once such a group is formed, in various embodiments, the user can select the group, for example, during the act (e.g., 224) of receiving, at the mobile device, the selection by the user of the recipient for the postcard. Groups can be saved, in a number of embodiments, and used for other postcards later. Further, in various embodiments, groups may be edited later to add or remove members. In a number of embodiments, when the user selects the group, copies of the postcard are sent to each recipient in the group. Thus, the user can send postcards to several people without selecting each person individually each time a postcard is sent, for instance, from the address book.

Moreover, method 200 further includes act 227 of searching an address book (e.g., 192 shown in FIG. 1) for a mailing address for the recipient. Method 200 further includes act 230 of sending (e.g., automatically) an electronic message to the recipient requesting the mailing address, which is performed if (e.g., only if) the address book does not contain the mailing address for the recipient (i.e., selected in act 224). In addition, method 200 includes (e.g., if the address book does not contain the mailing address for the recipient) for instance, in the following order, after act 230 of sending the electronic message to the recipient requesting the mailing address (and before act 248 of printing the postcard at the printing and mailing facility, which is described in more detail below), act 233 of holding and storing the image (e.g., received or identified in act 209), the personal message (e.g., received in act 221), and identification of the recipient (e.g., received or identified in act 224) prior to printing of the postcard (e.g., in act 248). Furthermore, method 200 includes, in this situation, act 239 of receiving, from the recipient, the mailing address of the recipient (e.g., in response to the message sent in act 230).

Further, in the embodiment shown, method 200 further includes act 242 of automatically updating the address book (e.g., 292 shown in FIG. 1) for the recipient by adding the mailing address (i.e., of the recipient). Act 242 can be performed after act 239 of receiving, from the recipient, the mailing address of the recipient. In some embodiments, the user may be asked whether to update the address book with the address that has been received before the change is made. Even further, method 200 includes act 236 of receiving, for example, at the mobile device, authorization from the user for payment for sending the postcard. In a number of embodiments, the user may be prompted for this authorization. Further still, method 200 includes act 245 of transmitting, over the network (e.g., 130 shown in FIG. 1) from the mobile device to a printing and mailing facility, the image for the postcard, the personal message, and the mailing address, and act 248 of printing the postcard at the printing and mailing facility (e.g., 120). In a number of embodiments, the image, the personal message, and the mailing address are all printed on the postcard (e.g., in act 248). Even further still, method 200 includes act 251 of mailing the postcard to the recipient.

These examples illustrate a number of different embodiments, but are not intended to be limiting. Further, particular embodiments include various means for accomplishing one or more of the particular acts or functions described herein. Other embodiments may be apparent to a person of ordinary skill in the art having studied this document.

What is claimed is:

1. A software application for a mobile device for sending a mail item, the software application comprising:
a user interface component that provides for selection by the user to send the mail item;
a message input component that provides for the user to enter a personal message for the mail item;
a recipient selection component that provides for the user to select a recipient for the mail item from an address book database;
a mailing address retrieval component that obtains an address for the recipient from the address book database for the mail item;
a mailing address obtaining component that contacts the recipient of the mail item requesting the mailing address of the recipient if the address book database does not contain the mailing address of the recipient, wherein the mailing address obtaining component automatically sends an electronic message to the recipient requesting the mailing address;
a payment component that obtains authorization from the user for payment for sending the mail item; and
a communication component that automatically sends the personal message and the mailing address for mailing the mail item to the recipient.

2. The software application of claim 1 further comprising a holding component that stores the personal message and identification of the recipient, wherein the holding component automatically instructs the communication component to send the personal message and the mailing address for mailing to the recipient when the mailing address obtaining component obtains the mailing address from the recipient.

3. The software application of claim 1 wherein the mailing address obtaining component automatically updates the address book for the recipient by adding the mailing address when the mailing address obtaining component obtains the mailing address from the recipient.

4. The software application of claim 1 wherein the software application further comprises an image selection component that provides for user selection of a picture for the mail item and the image selection component provides for the user to select a picture taken with the mobile device.

5. The software application of claim 1 wherein the software application further comprises an image selection component that provides for user selection of a picture for the mail item and the image selection component provides for the user to select a picture from a picture gallery stored on the mobile device.

6. The software application of claim 1 wherein the software application further comprises an image selection component that provides for user selection of a picture for the mail item and the image selection component provides for the user to crop a picture for the mail item.

7. A system for sending postcards from mobile phones, the system comprising:
a software application running on multiple mobile phones;
at least one printing and mailing facility;
at least one billing module;
wherein the mobile phones, the printing and mailing facility, and the billing module are in communication through at least one network;
the system comprising:
a user interface component that provides for selection by the user to prepare and send the postcard;
an image selection component that provides for user selection of a picture for the postcard;
a message input component that provides for the user to enter a personal message for the postcard;
a recipient selection component that provides for the user to select a recipient for the postcard from an address book database;
a mailing address retrieval component that obtains an address for the recipient from the address book database for the postcard;
a mailing address obtaining component that contacts the recipient of the postcard for the mailing address of the recipient if the address book database does not contain the mailing address of the recipient, wherein the mailing address obtaining component automatically sends an electronic message to the recipient requesting the mailing address;
a payment component that obtains authorization from the user for payment for sending the postcard; and
a communication component that automatically sends the picture, the personal message, and the mailing address to the at least one printing and mailing facility via the at least one network for printing the postcard and mailing to the recipient.

8. The system for sending postcards of claim 7 further comprising a holding component that stores the picture, the personal message, and identification of the recipient, wherein the holding component automatically instructs the communication component to send the picture, the personal message, and the mailing address to the at least one printing and mailing facility for printing and mailing to the recipient when the mailing address obtaining component obtains the mailing address from the recipient.

9. The system for sending postcards of claim 7 wherein the mailing address obtaining component automatically updates the address book for the recipient on the mobile phone running the software application by adding the mailing address when the mailing address obtaining component obtains the mailing address from the recipient.

10. The system for sending postcards of claim 7 wherein the image selection component provides for the user to select a picture taken by the mobile phone running the software application.

11. The system for sending postcards of claim 7 wherein the image selection component provides for the user to select a picture from a picture gallery stored on the mobile phone running the software application.

12. The system for sending postcards of claim 7 wherein the image selection component provides for the user to crop a picture for the postcard.

13. A computer and network implemented method of simplifying the sending of postcards, the method comprising at least the acts of:
receiving, at a mobile device containing a digital processor, an instruction from a user to prepare a postcard;
receiving, at the mobile device, a selection by the user of an image for the postcard;
receiving, at the mobile device, from the user, a personal message for printing on the postcard;
receiving, at the mobile device, a selection by the user of a recipient for the postcard;
searching an address book for a mailing address for the recipient;
if the address book does not contain the mailing address for the recipient, automatically sending an electronic message to the recipient requesting the mailing address;
receiving, at the mobile device, authorization from the user for payment for sending the postcard;
transmitting, over the network from the mobile device to a printing and mailing facility, the image for the postcard, the personal message, and the mailing address;
printing the postcard at the printing and mailing facility, wherein the image, the personal message, and the mailing address are all printed on the postcard; and
mailing the postcard to the recipient.

14. The method of claim 13 wherein if the address book does not contain the mailing address for the recipient, the method further comprises, in the following order, after the act of sending the electronic message to the recipient requesting the mailing address, and before the act of printing the postcard at the printing and mailing facility, the acts of:
holding and storing the image, the personal message, and identification of the recipient prior to printing of the postcard; and
receiving, from the recipient, the mailing address of the recipient.

15. The method of claim 13 further comprising the acts of:
receiving, from the recipient, the mailing address of the recipient; and
automatically updating the address book for the recipient by adding the mailing address.

16. The method of claim 13 wherein the act of receiving, at the mobile device, a selection by the user of an image for the postcard comprises providing for the user to select a picture taken with the mobile device.

17. The method of claim 13 wherein the act of receiving, at the mobile device, a selection by the user of an image for the postcard comprises prompting the user to select a picture from a picture gallery stored on the mobile device.

18. The method of claim 13 wherein the act of receiving, at the mobile device, a selection by the user of an image for the postcard comprises prompting the user to select a picture from a picture gallery stored on a web-based social network site.

19. The method of claim 13 further comprising an act of prompting the user to crop the image for the postcard.

20. The method of claim 13 further comprising an act of prompting the user to form a group of recipients for the postcard wherein the user can select the group during the act of receiving, at the mobile device, the selection by the user of the recipient for the postcard, wherein when the user selects the group, copies of the postcard are sent to each recipient in the group.
